(19) United States
(12) Patent Application Publication
(10) Pub. No.: US 2016/0076748 A1
(43) Pub. Date: Mar. 17, 2016

(54) System and Apparatus for Dual LED Light Bar

(71) Applicant: Lisa Sievers, San Carlos, CA (US)

(72) Inventors: Lisa Sievers, San Carlos, CA (US); Steven A. Sievers, San Carlos, CA (US); Dylan James Sievers, San Carlos, CA (US)

(21) Appl. No.: 14/953,445

(22) Filed: Nov. 30, 2015

Related U.S. Application Data
(63) Continuation-in-part of application No. 13/865,968, filed on Apr. 18, 2013, now abandoned.
(60) Provisional application No. 61/636,585, filed on Apr. 20, 2012.

(51) Int. Cl. F21V 23/04; F21K 99/00; F21V 29/75

(52) U.S. Cl. CPC F21V 23/0435; F21V 29/75; F21K 9/50; F21Y 2101/02

(57) ABSTRACT

A variable color light system includes multiple dual color light emitting diodes (LED's) arranged in a light bar. The dual LED's are arranged with a common cathode and two anodes. The light system includes a switch that controls the power to the light system. The system is controlled to power a first anode, a second anode, or neither anodes. When the first anode is powered, the dual LED's emit a first color. When the second anode is powered, the dual LED's emit a second color. The light system is LED driven. The dual LED light system can be used in a light bar that can be used on a vehicle, an off-road vehicle, a recreational vehicle, security parking lot light fixture or a boat.

### CROSS REFERENCE TO RELATED APPLICATIONS

This application is a Continuation In Part of application Ser. No. 13/865,978 filed on Apr. 18, 2013; and incorporates the entirety of same by reference herein. Further, the Non-provisional patent application Ser. No. 13/865,978 claims priority of the Provisional patent application No. 61/636,585 filed on date Apr. 20, 2012; and incorporate the entirety of same by reference herein.

### BACKGROUND OF THE INVENTION

1. Field of the Invention

This invention relates to the field of lighting using multiple colored light emitting diodes (LED's).

2. Description of Related Art

LED's are used in various types of light systems, including indoor and outdoor lighting, automobile lighting and accessory lighting. LED's are useful in providing energy efficient bright light in various different colors. In vehicle accessory lighting, LED's can be used in light bars that can be mounted to vehicles, such as off road trucks, four-wheelers, racing vehicles, farm equipment, and recreational vehicles, or boats. Light bars that mount to vehicles typically use one or multiple rows of LED's of a single color. If multiple colors are desired in one high-power light bar, the light bar is typically equipped with a first array of single-color LED's in one color, and a second array of a single-color LED's in a different color. In these light bars, when the first array of single-color LED's is turned on, the first array of LED's emits a color. To emit the second color, the first array of LED's is turned off and a second group of single-color LED's is turned on. For example in a prior art light bar, a white and amber light bar may have a row of ten white LED's and a row of ten amber LED's for a total of twenty LED's. When a user selects the white light to be emitted, the ten white LED's are turned on, while the ten amber LED's are turned off. When a user selects the amber light, the ten amber LED's are turned on, and the ten white LED's are turned off. In the current variable color light bars, a given area of LED's is not being used when that color is turned off. This causes light output to be less in a variable color light bar than in a single-color light bar, because fewer LED's are being used to emit one color. In this prior art example, only ten LED's can emit white light. If the user desired more white light, the user could replace the amber LED's with white LED's and lose the amber lighting. Or, the user could add an additional light bar, which would take up more space on the vehicle. So as to reduce the complexity and length of the Detailed Specification, and to fully establish the state of the art in certain areas of technology, Applicant(s) herein expressly incorporate(s) by reference all of the following material identified in each numbered paragraph below.

U.S. Publication No. 2011/0074300 of Hsu describes a dual colored LED decoration lamp. Two individual single-color LED's of different colors are cross-linked together and then placed in a string where the string is powered in one direction at a time. Thus, two single-color LED's are placed close together, each making half of the dual colored LED.

U.S. Pat. No. 8,325,029 to Brooking describes a dual color light bar using a pair of light emitting chips for each of a plurality of light emitting diodes where one light emitting chip is energized at a time to produce one of two different colors of light.

U.S. Pat. No. 8,325,029 to Georgitsis describes a lighting systems configured to provide vehicle lighting using light emitting diodes (LED'S).

U.S. Pat. No. 8,287,144 to Pedersen describes LED bar modules comprising a number of LED groups where the LED groups comprise a number of LED's that have different colors where the LED's are electrically coupled to a color controller for generating light with changing colors.

U.S. Publication 20130033857 of Lin describes a LED light bar with separated portions located on the housing with LED package devices disposed on a circuit board where the LED package devices of each of the groups forms a closed loop.

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), applicant(s) will amend the specification to expressly recite the essential material that is incorporated by reference as allowed by the applicable rules.

### SUMMARY OF THE INVENTION

The present invention provides among other things a variable color LED light system. The light system provides efficient lighting using dual, tri, Quad colored or multiple colored LED's. However, in the present invention each dual LED used in the light system is configured to emit at least two colors depending on the electrical lead connected to the power. The light system can be used in automobiles, boats, security parking lighting, recreational vehicles, off road vehicles, and the likes. In one embodiment of the present invention, the invention provides a plurality of LED's arranged in a light bar wherein each group of the plurality of LED groups comprises at least two LED's. A first LED of an LED group from the plurality of LED groups is configured to emit a first color upon application of a voltage to a first anode on the first LED. A second LED in a same LED group as the first LED from the plurality of LED groups is configured to emit a second color upon application of a voltage to a second anode on the second LED. There may be at least one electrical bus electrically coupled to the plurality of LED groups and configured to turn on or off one of the first color of the first LED and the second color of the second LED when the electrical bus electrically coupled to at least the first and second anodes is electrically coupled to at least one switch. The switch may include at least three settings including a first “ON” setting to illuminate first color on closing the circuit with the switch, an “OFF” setting to stop illumination of the plurality of LED groups, and a second “ON” setting to illuminate second color on closing circuit with the switch. Each LED group of the plurality of LED groups may be separately coupled to the electrical bus. In the present invention, the first LED and second LED may be in the same package; however this may be extended to multiple LED's in the same package. The emitted light from the first and second LED's illuminates a lens. The first LED and second LED may be electrically coupled to the electrical bus through a LED driver. The first LED and second LED may be surface mounted (employing Surface Mount Technology, SMT) directly on a printed circuit board (PCB) and heat sink wherein the emitted light from the first and second LED's illuminate the lens. The first and second LED's may share the same lens for the output. Similarly, in case of multiple LED's, the same lens may be shared by the multiple LED sources. There may be a third LED in the same LED group as the first LED and the second LED, the third LED configured to emit a third color upon application of a voltage to a third anode on the third LED. The third anode may be electrically coupled to the electrical bus and the switch may further comprise a ‘fourth setting’ creating a resistance to produce dimming effect on at least one of the first LED group; and the second LED group. The first LED, second LED, and third LED may be in the same package. As mentioned before, this may be extended to multiple LED's in the same package. The first LED, the second LED, and the third LED may be surface mounted directly on a printed circuit board and heat sink. The first LED, the second LED, and the third LED may emit light to illuminate the same lens. The plurality of LED's may include twenty LED's arranged in two rows in the light bar. The plurality of LED's may include twenty LED's arranged in one row in the light bar. Similarly different permutations and combinations may be possible. The first color may be white and the second color may be amber or any RGB (Red, Green, Blue) color combination or any other solid color. These LED's may be infrared LED's emitting infra red rays enhancing vehicle's night vision capabilities. The light bar may be configured to couple to a vehicle, an off-road vehicle, a recreational vehicle, security parking lighting or a boat and the likes. Additional resistance may be added to the anode of the first or second LED to reduce the current flow to the first LED or the second LED resulting in activating the dimming mode of LED's. The user may switch from enabling the light bar to emit all Infrared lights during night vision or for security applications to emitting all amber colored lights while driving amidst fog. Similarly, the user may switch the light bar to emit all white lights for area lighting based on the distance requirements. The present invention also finds application wherein we are able to use the same light fixture or bar (operating 120 V AC) on buildings wherein the amber colored light is required for parking and the white colored light for scene view.

In other embodiments, the invention may include a variable color light display device, comprising a plurality of variable color light emitting diode (LED) groups arranged in a light bar, each of the plurality of variable color LED groups configured to separately couple to at least one electrical bus and further comprising LED's having at least three electrical contacts. There may be a first electrical contact common to the plurality of variable color LED groups that is coupled to a first bus. There may be a second electrical contact that is electrically coupled to a first color of the variable color LED groups and is electrically coupled to a second bus. There may be a third electrical contact that is electrically coupled to a second color of the variable color LED groups and is electrically coupled to a second bus. There may be a fourth electrical lead coupled to a third color of the variable color LED's. The invention may be configured to turn on the first color and the second color when a voltage source is electrically coupled to the first and second electrical buses wherein a complete circuit for the first color is realized by electrically coupling the second electrical bus to the voltage source and a complete circuit for the second color is realized by electrically coupling the third electrical bus to the voltage source. The variable color LED's may be turned off by disconnecting both the second electrical bus and the third electrical bus from the voltage source.

There may be plurality of variable color LED's that are arranged in a light bar. The light bar may be configured to couple onto a vehicle, an off-road vehicle, a recreational vehicle, security parking lighting, a boat or the likes. The plurality of variable color LED's may be dual, tri, quad or multiple colored LED chips.

In still other embodiments, the invention may include a display device having a plurality of variable color light emitting diodes (LED) among a plurality of LED groups. There may be a first display area configured to display at least two colors of the LED groups. There may be an electrical bus coupled to the variable color LED's and configured to turn on one of the first color and the second color of the variable color LED's when electrical current flows from the electrical bus to the plurality of LED groups, wherein each LED group has a separate electrical coupling to the electrical bus. The first display area may be a light bar. The light bar may be configured to couple to a vehicle, an off-road vehicle, a recreational vehicle, security parking lighting or a boat. The light bar may comprise twenty dual LED's arranged in at least one row. Alternatively, the light bar may comprise twenty dual LED's arranged in two rows. Similarly other permutations and combinations may be possible. Each variable color LED configured to emit at least two colors but may also emit other RGB color combinations and Infrared light.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. §112(f). Thus, the use of the words “function,” “means” or “step” in the Detailed Description or Description of the Drawings or claims is not intended to somehow indicate a desire to invoke the special provisions of 35 U.S.C. §112(f), to define the invention. To the contrary, if the provisions of 35 U.S.C. §112(f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . “or “step for performing the function of . . . ,” if the claims also recite any structure, material or acts in support of that means or step, or that perform the recited function, then it is the clear intention of the inventors not to invoke the provisions of 35 U.S.C. §112(f). Moreover, even if the provisions of 35 U.S.C. §112(f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1A representatively depicts a front view of an embodiment of the light bar and FIG. 1B depicts a cross sectional view of the light bar and FIG. 1C depicts an exploded view of the light bar, FIG.1D depicts a close view of wired end caps with gore breather® vents and FIG. 1E depicts a section of rear view of the light bar.

FIG. 2 depicts a circuit board layout, according to one embodiment of the present invention.

FIG. 3 depicts a circuit board layout, according to another embodiment of the present invention.

FIG. 4 depicts schematics of the overall device, according to one embodiment of the present invention.

FIGS. 5-10 depict partial and more detailed schematics of the device, according to one embodiment of the present invention.

FIGS. 11, 12 and 13 depicts various LED driver schematic circuits.

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It shall be noted that there are many different and alternative configurations, devices and technologies to which the disclosed inventions may be applied. The full scope of the inventions is not limited to the examples that are described below.

Conventional LED light bars with high intensity light output suitable for off-road vehicles, recreational vehicles, or boats found in the art generally use single color LED lamps and output light with only a single color. Variable color LED light bars with continuous or flashing high power light output are desired in many applications some of which include but not limited to off-road vehicles, a recreational vehicles, security parking lighting and boats wherein additional high intensity lighting with a different color is needed. LED light bars require continuous high efficiency, high reliability operation. At the same time they need to be compact, lightweight, and rugged. Realizing high power, variable color LED output using conventional LED light bars found in the art would require a light bar of double the size of a single color LED light bar with a given power since additional LED's and supporting driver circuitry would need to be realized to support the additional light color. Conventional variable color LED light bars lack the ability to power high power LED's in part because high power LED's require relatively high currents that may approach 1 ampere or more. With the advancements in technology, the present invention aims at operating either at 1 ampere or more. The conventional variable color light bars cannot support this high current for large numbers of LED's needed for a high power light bar; a typical high power LED light bar may require 10, 20 or more LED's. In addition, structures for realizing efficient, compact dual LED light bars that allow for arbitrarily sized LED light bars from just 4-6 LED's to LED light bars with 20, 40, 80 or more LED emitters is desired. The present invention addresses the need for compact, lightweight, high power, variable color LED light bars that are highly scalable by providing modular circuit architecture based on “groups” of variable color LED's where the LED groups are coupled separately to an electrical bus that supplies the power needed to drive the LED's.

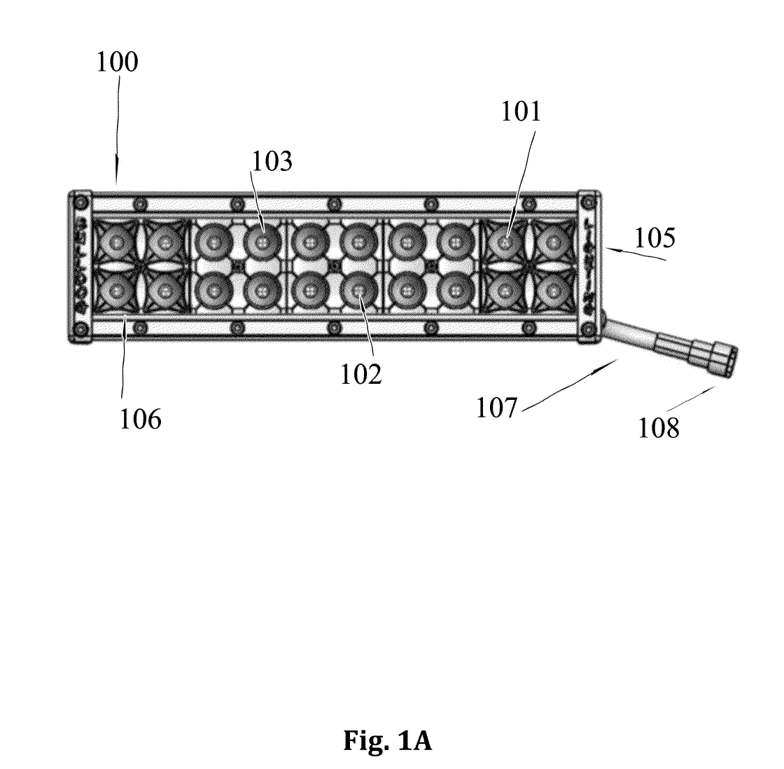

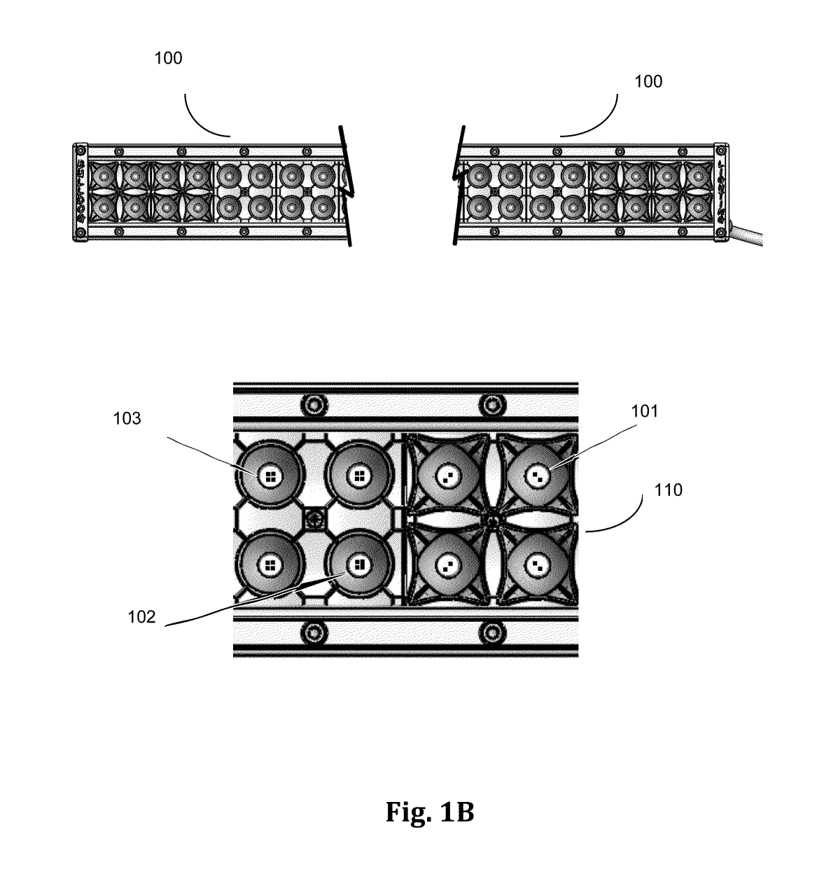

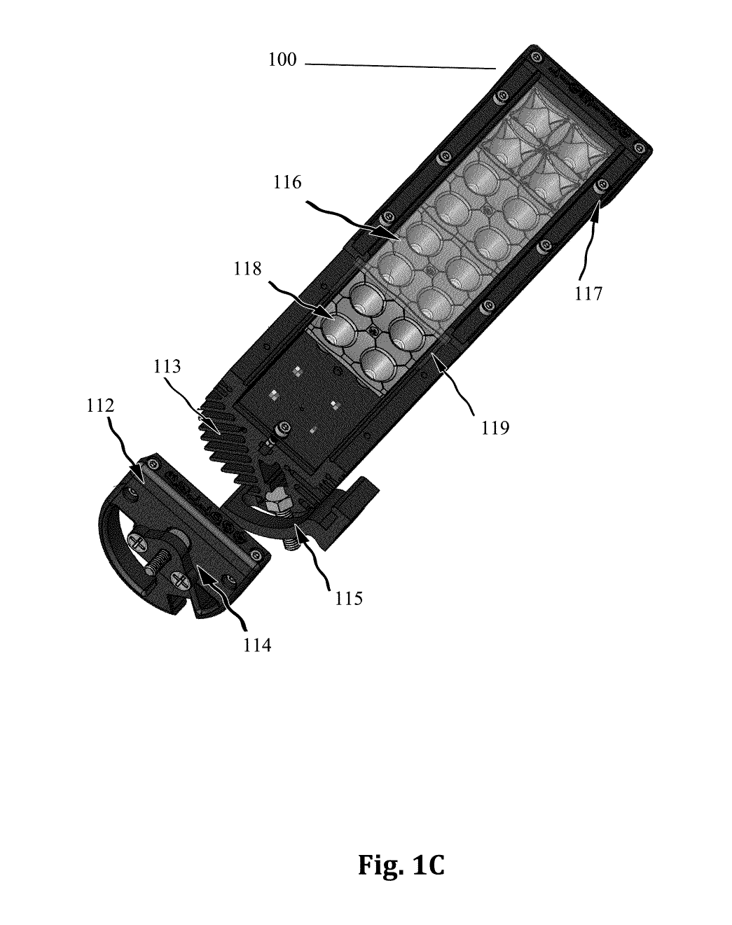

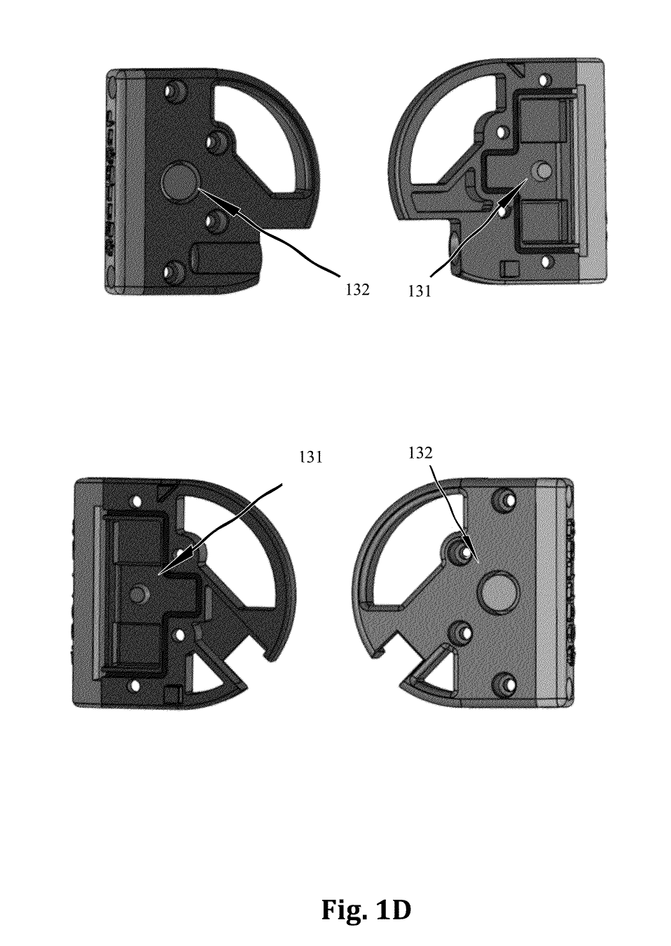

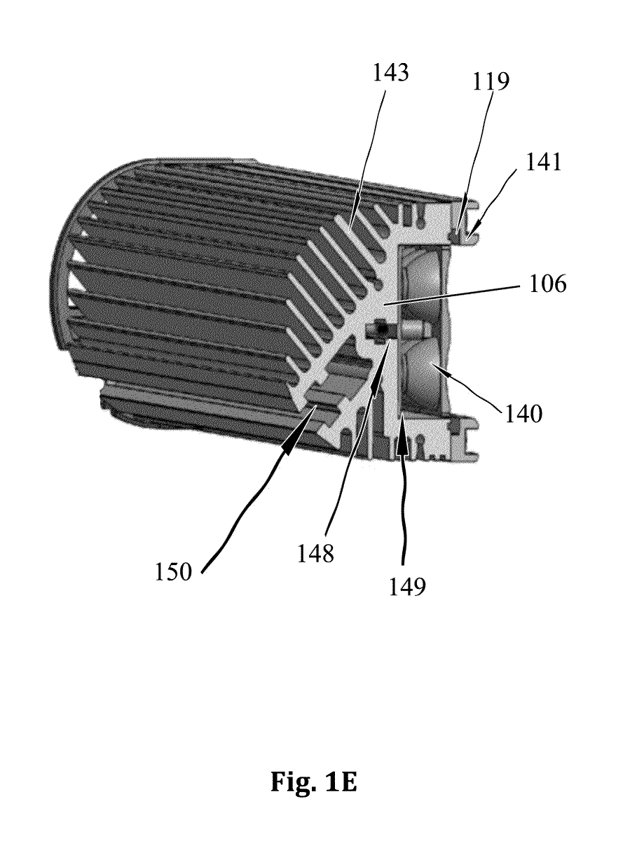

In one application of the invention, referring now to FIG. 1A, a light bar according to various aspects of the invention is depicted in the front view. In the embodiment pictured in FIG. 1A, the light bar 100 comprises two rows of total twenty LED's (each row having ten LED's) within a housing 106. An end cap with gore breather® 105 is attached to the wire whip 107 followed by a AC or DC electrical connector 108. Gore breather® vents effectively manage extreme difference in temperature, pressure and humidity thus provides a safe and effective option for moisture venting (during conditions like rain, fog etc.) The LED's 101 may be dual-color LED's, tri-color LED's or multiple colored LED's, they can be pairs or trios of single LED's. For e.g. In one combination, the first and second row may consist of all dual LED's or consist of a combination of dual LED's 101, tri LED's 102 and quad LED's 103 as depicted in FIG. 1A. As discussed above, in one embodiment of the invention, the light bar 100 may include twenty dual LED's 101. In other embodiments of the invention, pairs or trios of single LED's may be used. Therefore, without loss of generality, it should be understood that references to “dual LED's” or “triple LED's” may also refer to pairs or trios of single LED's placed separately on the circuit board. The light bar is not limited to twenty dual LED's or pairs of LED's. Any number of LED's can be used in the light bar system. Similarly, the light bar may comprise of any number of rows of LED's within the housing 106. For further describing the invention, we are using dual LED's as the standard example. The dual LED's 101 each emit at least two different colors. The colors emitted by the LED's 101 depend on the diode used, and could be any color but not limited to white and amber lights. The colors emitted by the LED's could be any RGB color combinations and may even be Infrared lights. As an example, the dual LED's 101 are diodes that emit both amber and white light. The technology now used is Surface Mount Technology (SMT) to mount LED's on the printed circuit board (PCB). In other embodiments, any solid color may be used for the dual LED's 101. When a voltage is applied to a first anode, all twenty dual LED's 101 in the light bar 100 emit amber-colored light. When a voltage is applied to a second anode, all twenty dual LED's 101 in the light bar 100 emit white light. The LED's 101 may be surrounded by a reflective material to reflect the light emitted by the LED's. The housing 106 may be comprised of any suitable material for supporting the LED's 101, such as metal, plastic, fiberglass or the like. The light bar 100 also comprises a mounting portion 115 (shown in FIG. 1C) where the light bar 100 can mount to a vehicle, security lighting apparatus or a boat or any security parking light system. The LED's 101 could also be tri-color LED's. Tri-color LED's emitting a third color, for example, red, when a voltage is applied to a third anode. LED's with one, two, or three colors described here are exemplary. Any number of LED's may be used without departing from the scope of the invention.

FIG. 1B depicts a light bar that can be in many lengths 100, illustrating a close look at the LED 110, dual LED 101, tri LED 102 and quad LED 103.

FIG. 1C depicts an exploded view of the light bar 100 with various components including an end cap 112 with gore breather vents® 114 to effectively vent moisture; a heat sink 113 provides maximum surface area for heat dissipation from the LED's; PCB 118 designed with an efficient circuit to allow maximum power to the LED's thus optimizing light output and minimizing over heating of the LED's; mounting system 115; durable screws 117 to assemble the light bar components; unbreakable and durable polycarbonate lens 116 and gasket 119 provide a watertight fixture to the light bar assembly.

FIG. 1D illustrates a close inside view of wired end cap with gore breather 132 and outside view of non-wired end cap with gore breather 131. Both combinations can be employed in the present invention.

FIG. 1E depicts a cross sectional rear view of the housing 106; heat fins 143 increase the overall surface area of the heat sink for dissipating heat from the LED's; reflective material in reflectors 140 for providing superior reflectivity, rails 141 for mounting lens; gasket 119 between polycarbonate lens (Shown in FIG. 1C) and rails; PCB 149 with surface mounted LED's; a channel 148 for PCB attachment by screws and a channel 150 for bottom mounting.

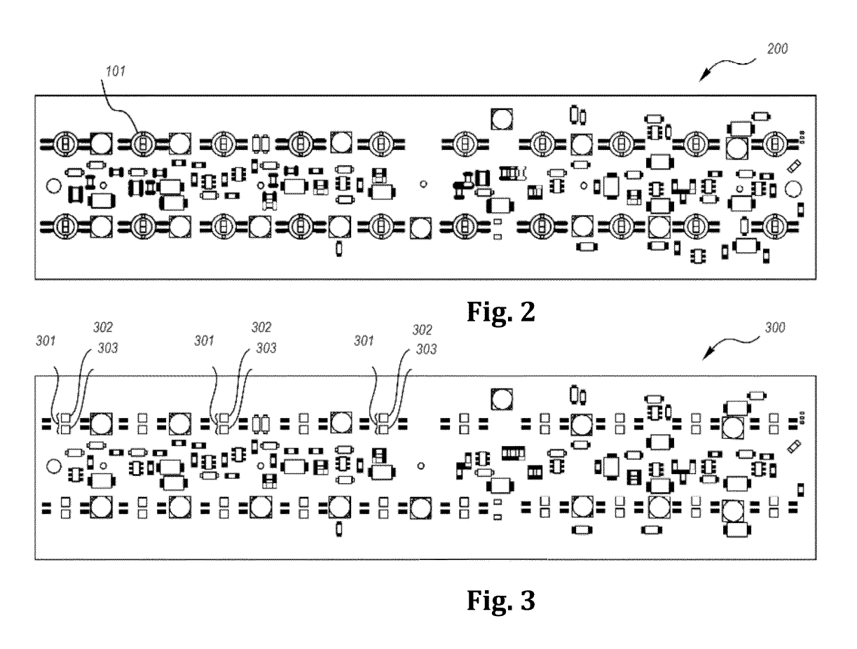

FIG. 2 depicts the circuit board layout 200 for an embodiment of the dual LED light bar system. In the embodiment of FIG. 2, the circuit board layout 200 comprises twenty dual LED's 101. Each of the dual LED's 101 has at least three leads: either two anodes and a common cathode or two cathodes and a common anode. In case of a string of single color LED's, it may have 2 anodes and a common cathode. Various dual-color LED chips will operate in the circuit board layout 200 of FIG. 2. In one embodiment of the circuit board layout 200, the dual-color LED's 101 each light up in either color depending on which lead is coupled to a voltage. For example in FIG. 2, when the amber anode of each dual LED 101 is coupled to voltage, each of the twenty dual LED's 101 emits amber light. When the white anode of each dual LED 101 is coupled to a voltage, each of the twenty dual LED's 101 emits white light.

In another embodiment of FIG. 2, the dual LED's 101 have at least three leads: a cathode and two anodes. One of the anodes includes a resistor that allows the first color of the dual LED 101 to receive less power. The second anode of the dual LED 101 does not include the resistor thereby receiving full power. This embodiment can be used, for example, in brake lights. When the first anode is coupled to a voltage, the first color of the dual LED 101 is emitted at less than full brightness. When the second anode is coupled to a voltage, the second color of the dual LED 101 emits at full brightness. When used for brake lights, both colors of the dual LED 101 may be red. In this example, the first diode in the dual LED 101 would receive half power when the vehicle lights were on, thus allowing running lights. The second diode in the dual LED 101 would receive full power when the vehicle brakes were used, allowing the second diode to emit a brighter light to indicate braking.

FIG. 3A depicts the circuit board layout 300 for an embodiment of the dual LED light bar system. In the embodiment of FIG. 3, the circuit board layout 300 comprises twenty LED pairs 301 where each pair comprises two single LED's. Each of the first single LED's 302 and second single LED's 303 within the pairs of LED chips 301 has at least two contacts: either one or two anodes and a common cathode or two cathodes and a common anode. Various single-color LED's will operate in the circuit board layout 300 of FIG. 3. The LED pairs 301 are mounted to the printed circuit board that generally comprises a high thermal conductivity material to provide adequate heat sinking for the LED's. The LED pairs 301 are mounted to the printed circuit board and heat sink using SMD (Surface Mounted device) pick and place techniques. The LED pairs 301 may comprise semiconductor chips or packaged single-color LED's. The pairs of LED chips 301 are electrically coupled to the circuit through contacts on the backside of the chips. The LED chips 302 and 303 may be mounted to the printed circuit board using soldering. In the present embodiment of the circuit board layout 300, either a first color of LED chips 302 each emit light in either color depending on which LED chip 302 or 303 is coupled to a voltage. For example in FIG. 3, the first LED 302 of the pair of LED chips 301 may be configured to emit amber-colored light and the second LED 303 may be configured to emit white light. Likewise the pair 301 of LED chips may be configured to emit any RGB color combination light or Infra red light. When the anode of the first LED 302 is coupled to a voltage, each of the first LED's 302 of the LED pairs 301 emits amber light. When each second LED 303 of each LED pair 301 is coupled to a voltage, each of the second LED's 303 of the LED pairs 301 emits white light.

Analogous to the description of FIG. 2, in another embodiment of FIG. 3, two LED's each with a first anode and a first cathode may be used. One of the anodes of one of the LED's includes a resistor that allows the first LED 302 color of the LED pair 301 to receive less a voltage. The second LED 303 in the LED pair 301 does not include the resistor thereby receiving full power. Analogous to FIG. 2, this embodiment can be used, for example, in brake lights. When the first anode is coupled to a voltage, the first LED 302 of the LED pair 301 is emitted at less than full brightness. When the second LED 303 is coupled to a voltage, the second color of the LED pair 301 emits at full brightness. When used for brake lights, both colors of the LED pair 301 may be red. In this example, the first LED 302 in the LED pair 301 would receive half power when the vehicle lights were on, thus allowing running lights. The second LED 303 in the LED pair 301 would receive full power when the vehicle brakes were used, allowing the second diode to emit a brighter light to indicate braking.

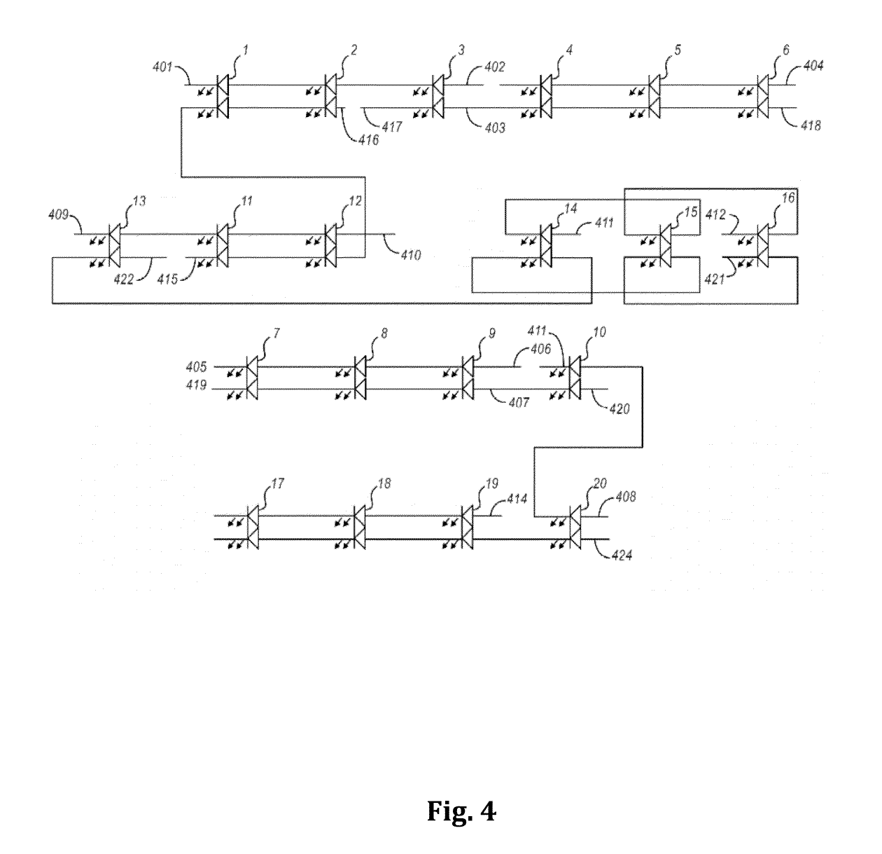

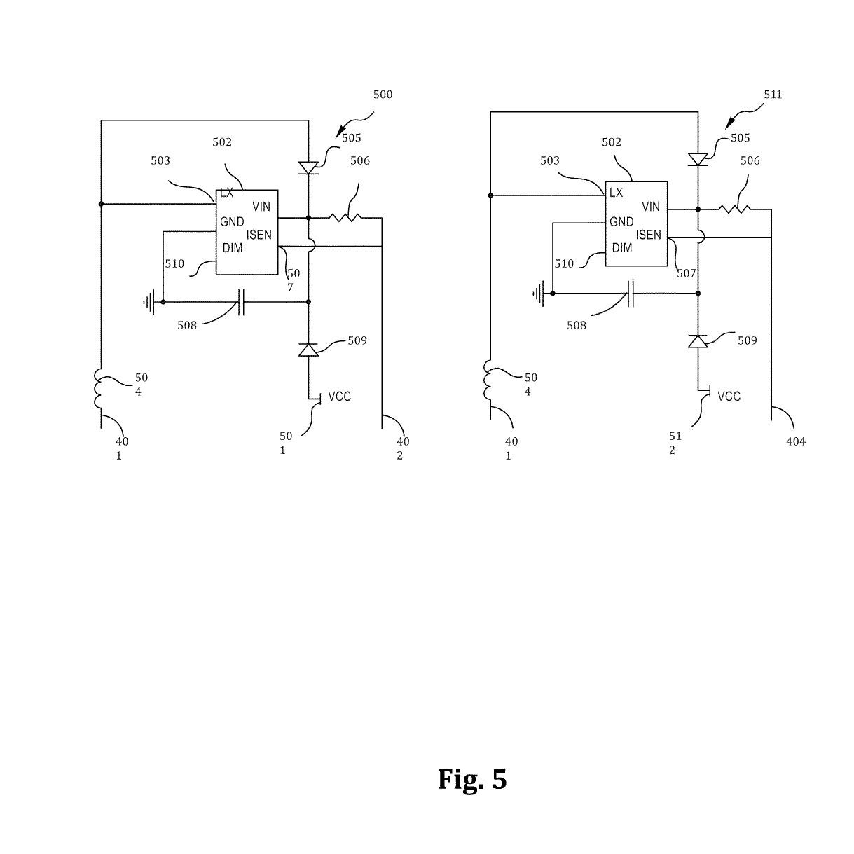

FIG. 4 depicts schematics of an embodiment of the circuitry for the light bar system. In the embodiment depicted by FIG. 3, each of the twenty dual LED's 1, 2, 3, 4, 5, 6, 7, 8, 9, 10, 11, 12, 13, 14, 15, 16, 17, 18, 19, and 20 (“1-20”) may be dual-color LED's, also called bi-color LED's. These LED's may also comprise pairs of separate discrete LED's. The twenty dual LED embodiment in FIG. 4 is meant to show one configuration of many configurations that could comprise dual LED light bars. The light bar system is not limited to twenty LED, and may contain any number of LED's. The dual LED's 1-20, shown symbolically in FIG. 4, can be powered by direct current DC or AC) input. Each LED within a LED group is biased by an LED driver. For clarity, the details of the driver are not shown in FIG. 4; FIGS. 5-10 show the details and connections of the LED to the LED drivers. Each LED group is coupled to the other LED sets by a common electrical ground. To enable high-power operation, the dual LED's 1-20 are broken into groups wherein each group has independent control and an independent connection to the electrical bus connections to anodes 401-424 that, during operation, supplies power to the dual LED's. This configuration allowing independent control and independent electrical coupling to the bus provides for high power scalability of the system, provides low resistance connections to the LED's, and prevents issues with excessive current and associated joule heating and electro-migration deterioration of the conductors in the circuitry. For example in FIG. 4, LED pairs 1, 2, and 3 comprise one LED group for a first color. Similarly, LED pairs 4, 5, and 6 comprise another LED group for a first color. An LED group for the second color includes LED's 3, 4, 5, and 6. The LED groups are depicted in more detail in FIGS. 4-9.

In the embodiment of the light bar depicted by the schematics of FIG. 4, there are twelve LED groups, seven LED groups for a first color, and five LED groups for a second color. In the example in FIG. 4, anodes 402, 404, 406, 408, 410, 411, and 414 are coupled to the dual LED's such that each dual LED 1-20 emits a first color when a voltage is supplied to anodes 402, 404, 406, 408, 410, 411, and 414. Each of the LED groups is electrically coupled to a common cathode or ground.

Anode 402 is electrically coupled to LED 3 and cathode 401 is electrically coupled to LED 1 as part of a first LED group comprising dual LED's 1, 2, and 3. When a voltage is applied to anode 402, LED's 1, 2, and 3 emit a first color. Anode 404 is coupled to LED 6 and cathode 403 is coupled to LED 4 as part of a second LED group comprising LED 4, 5, and 6. When a voltage is applied to anode 404, LED's 4, 5, and 6 emit a first color. Anode 406 is coupled to LED 9 and cathode 405 is coupled to LED 7 as part of a third LED group comprising LED's 7, 8, and 9. When a voltage is applied to anode 406, LED's 7, 8, and 9 emit a first color. Anode 408 is coupled to LED 20 and cathode 407 is coupled to LED set 10 as part of a fourth LED group comprising dual LED 10 and 20. When a voltage is applied to anode 408, LED s 10 and 20 emit a first color. Anode 410 is coupled to LED 12 and cathode 409 is coupled to LED 13 as part of a fifth LED group comprising LED's 11, 12, and 13. When a voltage is applied to anode 410, dual LED s 11, 12, and 13 emit a first color. Anode 411 is coupled to LED 14 and cathode 412 is coupled to LED set 16 as part of a sixth LED group comprising LED's 14, 15, and 16. When power is applied to anode 411, dual LED sets 14, 15, and 16 emit a first color. Anode 314 is coupled to LED 19 and cathode 413 is coupled to LED 17 as part of a seventh LED group comprising LED's 17, 18, and 19. When a voltage is applied to anode 414, dual LED's 17, 18, and 19 emit a first color.

In the example in FIG. 4, anodes 416, 418, 420, 422, and 424 are coupled to the corresponding LED's such that each LED's 1-20 emit a second color when a voltage is supplied to anodes 416, 418, 420, 422, and 424. Each of the LED groups is electrically coupled to a common cathode or ground. Anode 416 is coupled to LED set 2 and cathode 415 is coupled to LED 11 as part of an eighth LED driven group comprising dual LED s 1, 2, 11, and 12. When voltage is applied to anode 416, dual LED sets 1, 2, 11, and 12 emit a second color. Anode 418 is coupled to LED 6 and cathode 417 is coupled to LED 3 as part of a ninth LED group comprising dual LED's 3, 4, 5, and 6. When power is applied to anode 418, dual LED s 3, 4, 5, and 6 emit a second color. Anode 420 is coupled to LED 10 and cathode 419 is coupled to LED 7 as part of a tenth LED driven group comprising dual LED sets 7, 8, 9, and 10. When a voltage is applied to anode 420, LED sets 7, 8, 9, and 10 emit a second color. Anode 422 is coupled to LED 13 and cathode 321 is coupled to LED 16 as part of an eleventh LED driven group comprising LED sets 13, 14, 15, and 16. When a voltage is applied to anode 422, dual LED's s 13, 14, 15, and 16 emit a second color. Anode 424 is coupled to LED 20 and cathode 423 is coupled to LED 17 as part of a twelfth LED group comprising dual LED's 17, 18, 19, and 20. When a voltage is applied to anode 424, LED sets 17, 18, 19, and 20 emit a second color.

FIGS. 5-10, depict more detailed schematics of the light bar according to one embodiment. FIG. 5 shows a first LED group LED driver 500 used to electrically couple a first LED group with cathode 401 and anode 402 for a first color to an electrical bus at coupling point 501 and a second LEG group LED driver 511 for a second LED group with cathode 403 and anode 404 for a second color connected to an electrical bus at coupling point 512. The LED driver 500 generally operates as a continuous mode Buck converter (However it may operate as Buck or Boost or Buck-Boost converter) used to step the voltage down from the supply voltage 501 of 4-48V or higher down to a voltage of 3-5 V between the anode 402 and the cathode 401, in a preferred embodiment of the present invention. The LED driver 500 employs an integrated circuit 502 configured to apply an alternating high and low impedance coupling to a voltage source or ground at terminal 503 that produces a voltage drop across inductor 504 during a low impedance state as the inductor 504 initially resists current flow. When terminal 503 goes into a high impedance state, the magnetic field of inductor 504 discharges, allowing current to flow through diode 505. The net effect is that the average voltage seen between the anode 402 and the cathode 401 is reduced because of the voltage drop across inductor 504. The resulting current applied through anode 402 is sensed by the voltage drop across resistor 506 at terminal 507 of integrated circuit 502. To control the current through the LED the integrated circuit 502 adjusts the duration of the high and low impedance states produced at terminal 503 to adjust the average voltage between anode 402 and cathode 401. A capacitor 508 is used to smooth the ripple caused by the varying voltage across the inductor 504. Diode 509 is used to isolate the bus connection 501 from spurious transient voltages. Terminal 510 of integrated circuit 502 may be used to enable dimming of the light by applying a low voltage below 0.3 V for no light output and up to 2.5 V for maximum light output. The operation of the LED driver with respect to anode 404 and cathode 403 is identical to that described above.

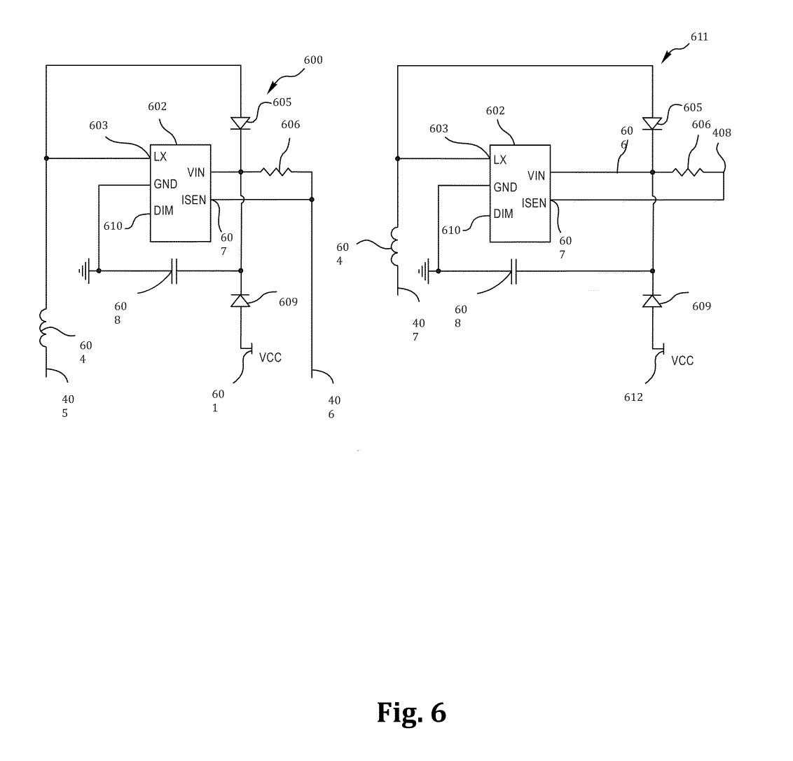

FIG. 6 shows an LED driver 600 for a third LED group that electrically couples with cathode 405 and anode 406 for a first color to an electrical bus at point 601. FIG. 6 also shows a LED driver 611 for a fourth LED group with cathode 407 and anode 408 for a first color that couples to an electrical bus at point 612. Components 502-510 in FIG. 6 function identically to correspondingly numbered items in FIG. 5.

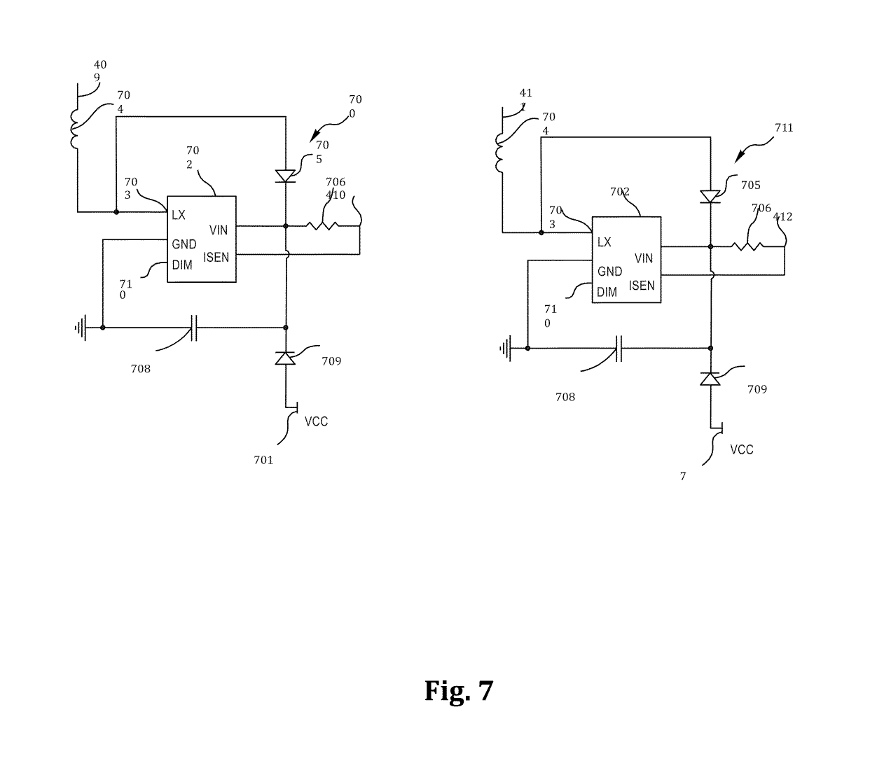

FIG. 7 shows an LED driver 700 for a third LED group that electrically couples with cathode 409 and anode 410 for a first color to an electrical bus at point 701. FIG. 7 also shows a LED driver 711 for a fourth LED group with cathode 411 and anode 412 for a first color that couples to an electrical bus at point 712. Elements 702-710 in FIG. 7 are identical to elements 502-510 in FIG. 5.

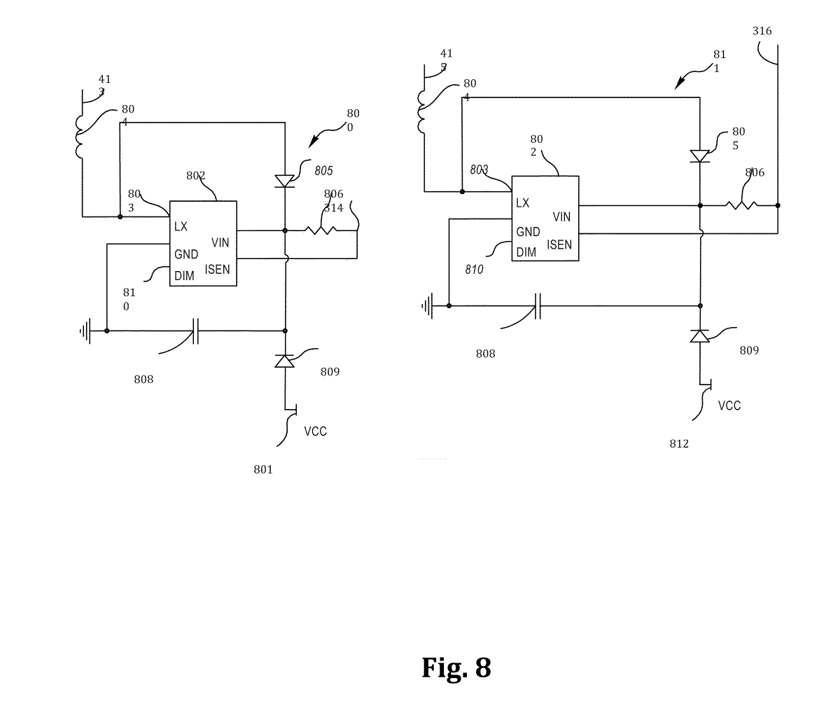

FIG. 8 shows an LED driver 800 for a third LED group that electrically couples with cathode 413 and anode 414 for a first color to an electrical bus at point 801. FIG. 7 also shows a LED driver 811 for a fourth LED group with cathode 415 and anode 416 for a first color that couples to an electrical bus at point 812. Elements 802-810 in FIG. 8 are identical to elements 502-510 in FIG. 5.

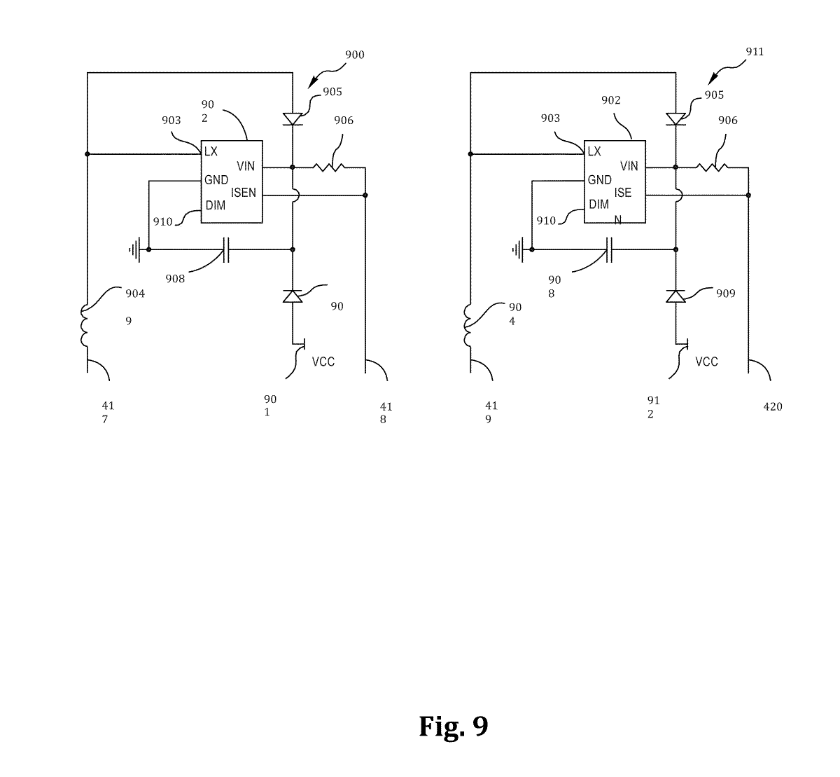

FIG. 9 shows an LED driver 900 for a third LED group that electrically couples with cathode 417 and anode 418 for a first color to an electrical bus at point 901. FIG. 9 also shows a LED driver 911 for a fourth LED group with cathode 419 and anode 420 for a first color that couples to an electrical bus at point 912. Elements 802-810 in FIG. 8 are identical to elements 502-510 in FIG. 5.

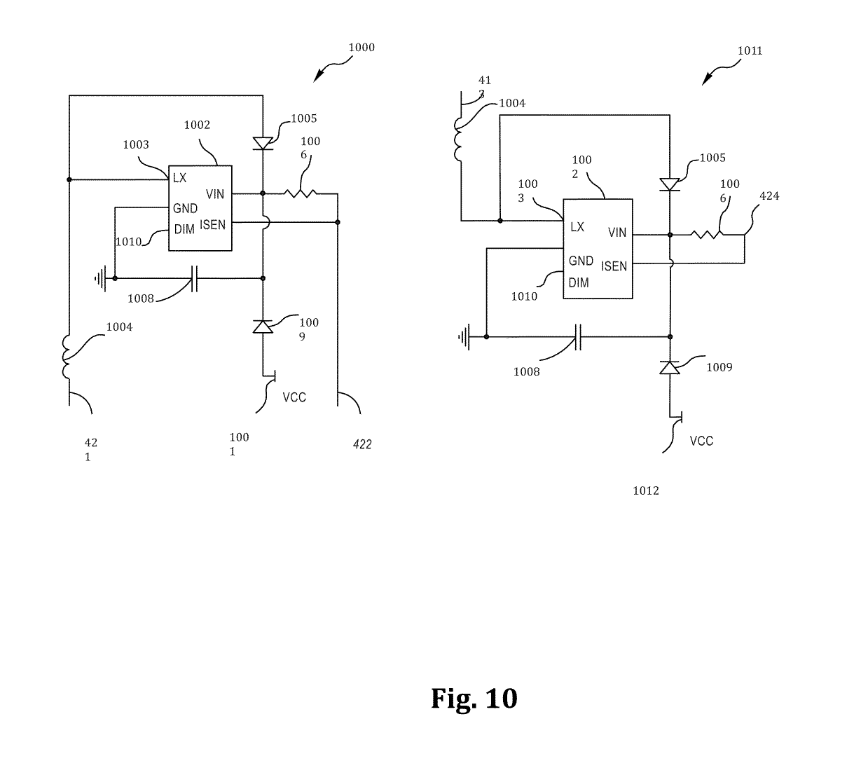

FIG. 10 shows an LED driver 1000 for a third LED group that electrically couples with cathode 421 and anode 422 for a first color to an electrical bus at point 1001. FIG. 9 also shows a LED driver 1011 for a fourth LED group with cathode 423 and anode 424 for a first color that couples to an electrical bus at point 1012. Elements 802-810 in FIG. 8 are identical to elements 502-510 in FIG. 5.

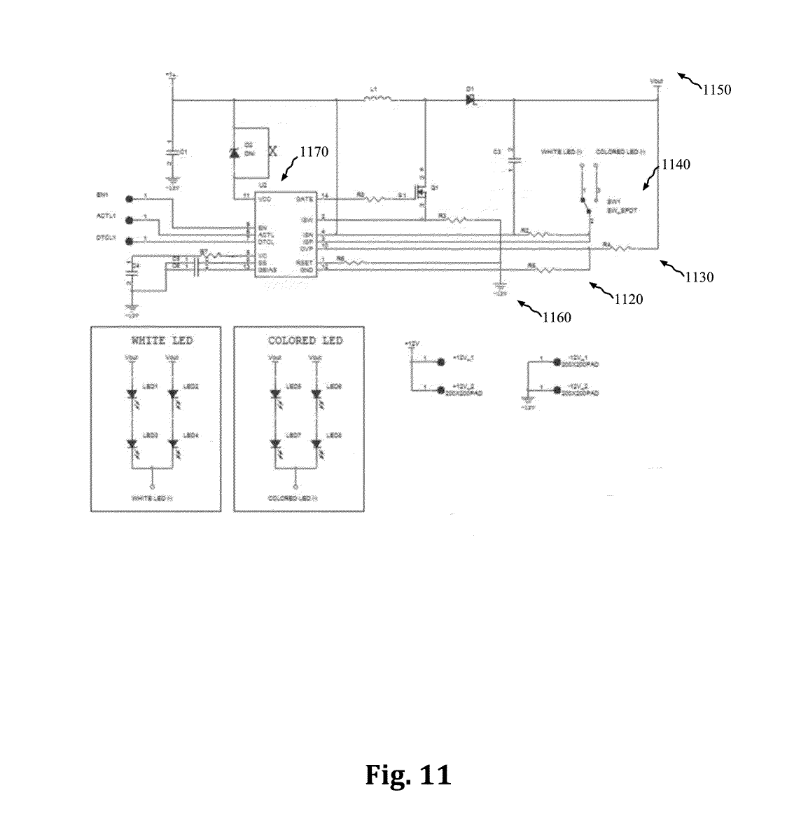

FIG. 11 shows a Circuit for LED driver capable of driving two sets of LED's; white and colored. Both sets of LED's shall operate one at a time which depends on the wiper position of the switch 1140. The LED's are supplied with a constant current source from the main power supply rail 1160. The controller 1170 connects the electrical bus 1150 with the switch 1140 for controlling the illumination of the first LED group and the second LED group. The controller 1170 also provides voltage protection by monitoring the level of the electrical bus 1150 through the divided resistors 1130 and 1120. The power supply rail used in the circuit is a boost converter. This power supply configuration will have a higher output voltage on the electrical bus 1150 compared to its input voltage.

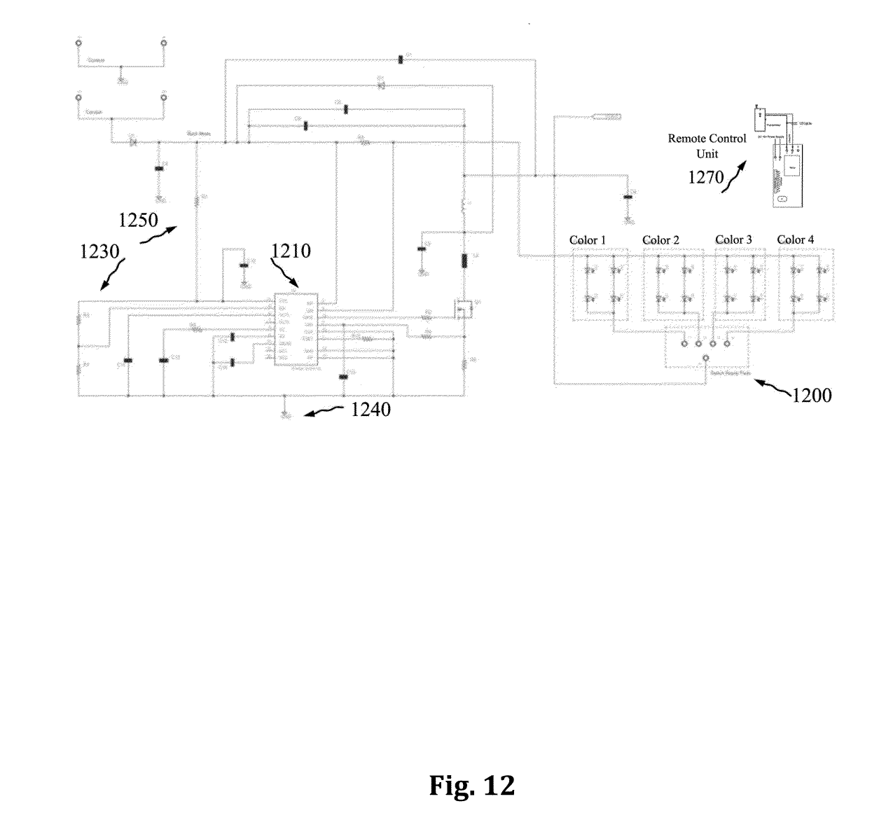

FIG. 12 shows another Circuit of LED driver able to drive four sets of LEDs; Color 1, Color 2, Color 3, and Color 4. The four LED groups will not operate simultaneously but depends on the wiper position of the switch 1200. The LEDs are supplied with a constant current source from the main power rail that is controlled by the controller 1210 by reading the voltage drop across the sense resistor 1250. The constant current operation makes the current steady and prevents the LEDs from flickering or changes in light intensity. The main power supply rail is a buck converter. A buck converter is a voltage step down converter. The controller IC 1210 provides an ‘over’ current protection by monitoring the voltage drop across the sense resistor 1230. In another preferred embodiment of the present invention, the switch further includes a third ON setting to illuminate third color on closing circuit with the switch.

In a preferred embodiment of the present invention, the switch 1200 includes a ‘ON’ setting to illuminate first color on closing the circuit with the switch; an ‘OFF’ setting to stop illumination of the plurality of LED groups; a second ON setting to illuminate second color on closing circuit with the switch.

In another preferred embodiment of the present invention, the switch 1200 further includes a fourth setting (Not shown in FIG. 12) creating a resistance to produce dimming effect on at least one of the LED groups. It would be readily apparent to those skilled in the art that resistance may be applied to any of the LED group to produce dimming effect without deviating from the scope of the present invention.

In another preferred embodiment of the present invention, the light system further includes a wireless unit 1270 connected to the electrical bus 1240 to receive signals for controlling the switch 1200. However, it would be readily apparent to those skilled in the art that the wireless unit 1270 may further be connected to PCB for receiving signals for controlling the switch 1200 without deviating from the scope of the present invention.

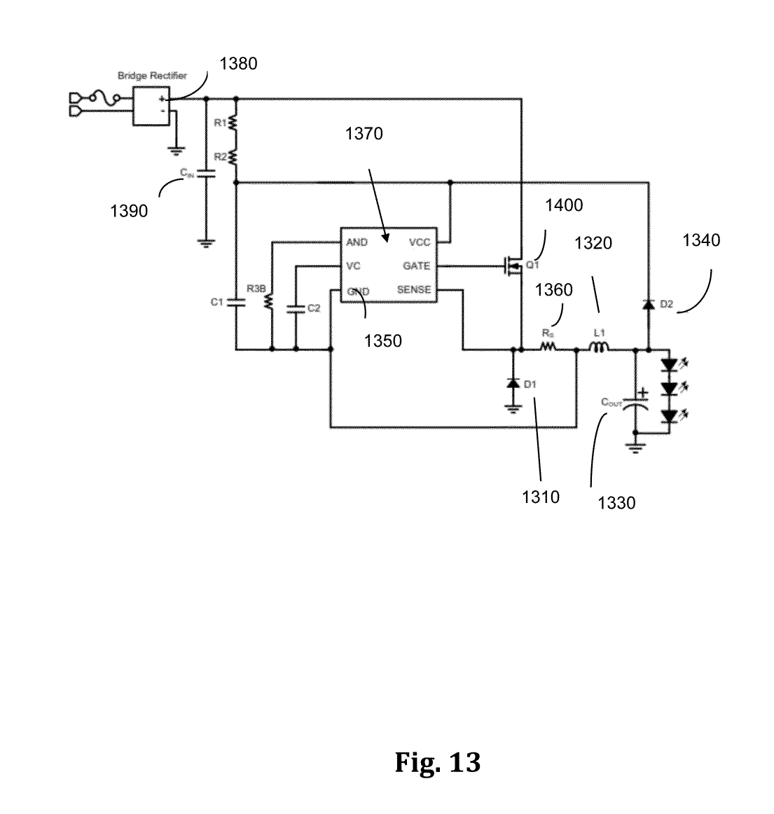

FIG. 13 is a circuit of an AC-DC LED driver. It is a non-isolated design hence saving a larger space for the transformer and makes the overall device's design compact. The above circuit operates as a buck converter. The circuit above can be designed to operate in a universal line voltage of 85-264 Vrms. The input AC voltage will be rectified by the bridge 1380 and then filtered by the input capacitor 1390. The supply of the controller is derived from the high voltage side through resistors R1 and R2 during start up. The capacitor C1 will charge and starts a timer. After the timer expires, the high voltage supply internal to the controller will turn off. During this time, the level of the output must be already stable to supply the VCC pin through the diode 1340. A zener diode and a small value resistor in series with the diode 1340 will be added for output voltages higher than 40V. The buck converter comprises the MOSFET 1400, diode 1310, inductor 1320 and output capacitor 1330. The PWM is provided by the controller GND 1350 pin. The constant current is set by the resistor 1360. The LED strings are can be configured to the required LED configuration.

There has thus been shown and described a light system. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

We claim:

1. A light system comprising:
a heat sink;
a electrical bus;
a plurality of light emitting diode (LED) groups arranged in the heat sink, each group of the plurality of LED groups comprising at least two LED's wherein:
a first LED group from the plurality of LED groups is configured to emit a first color upon application of voltage on the first LED group, wherein the first LED group is independently connected to the electrical bus;
a second LED group from the plurality of LED groups is configured to emit a second color upon application of a voltage on the second LED group, wherein the second LED group is independently coupled to the electrical bus; and
the electrical bus is electrically connected to the plurality of LED groups and configured to turn on or off one of the first color of the first LED and the second color of the second LED with a switch, the switch including at least three settings, comprising:
a first ON setting to illuminate first color on closing the circuit with the switch;
an OFF setting to stop illumination of the plurality of LED groups; and
a second ON setting to illuminate second color on closing circuit with the switch;
wherein the heat sink absorbs the heat released from the plurality of LED groups.

2. The light system of claim 1 further comprising a controller to connect the electrical bus with the switch for controlling the illumination of at least one of the LED groups.

3. The light system of claim 1 wherein the switch further comprising a fourth setting creating a resistance to produce dimming effect on at least one of the first LED group; and the second LED group.

4. The light system of claim 1, wherein the first LED group and the second LED group are attached directly to the electrical bus, wherein at least one of the emitted lights from the first and second LED's illuminates a lens.

5. The light system of claim 1 further comprising a third LED group from the plurality of LED groups is configured to emit a third color upon application of voltage on the third LED group, wherein the third LED group is independently connected to the electrical bus.

6. The light system of claim 5 wherein the switch further comprising a third ON setting to illuminate third color on closing circuit with the switch.

7. The light system of claim 5 further comprising a reflective material for surrounding each of the first LED group, the second LED group and the third LED group.

8. The light system of claim 5 further comprising a wireless unit connected to the electrical bus to receive signals for controlling the switch.

9. The light system of claim 5 further comprising a wireless unit on printed circuit board, driven by the controller to receive signals for controlling the switch.
